(19) United States
(12) Patent Application Publication
(10) Pub. No.: US 2014/0293188 A1
(43) Pub. Date: Oct. 2, 2014

(54) Displays with Local Dimming Elements

(71) Applicant: APPLE INC., Cupertino, CA (US)

(72) Inventors: Cheng Chen, San Jose, CA (US); Nicholas A. Rundle, San Jose, CA (US); Jun Qi, Cupertino, CA (US); Christiaan A. Ligtenberg, San Carlos, CA (US); Matthew Casebolt, Fremont, CA (US); Dinesh C. Mathew, Fremont, CA (US); Victor H. Yin, Cupertino, CA (US)

(21) Appl. No.: 13/854,651

(22) Filed: Apr. 1, 2013

(51) Int. Cl. G02F 1/1335

(52) U.S. Cl. CPC G02F 1/1336
USPC 349/65; 349/86; 349/62

(57) ABSTRACT

An electronic device is provided with a display such as a liquid crystal display. The display includes a liquid crystal display module an array of display pixels. A backlight unit is used to provide backlight illumination to the display module. A shutter module having local dimming elements is used to locally control the amount of light that is transmitted through the display. The local dimming elements can be formed from liquid crystal display structures, polymer-dispersed liquid crystal display structures, photovoltaic material, electrowetting display structures, and/or other suitable light controlling elements. Each local dimming element controls the amount of light that is transmitted through an overlapping region of the array of display pixels. The local dimming elements may be arranged in a uniform array having rows and columns or may be shaped and sized differently and located in specific regions of the display.

### BACKGROUND

This relates generally to electronic devices and, more particularly, to electronic devices with displays.

Electronic devices often include displays. For example, cellular telephones and portable computers often include displays for presenting information to a user.

Displays such as liquid crystal displays contain a thin layer of liquid crystal material interposed between a color filter layer and a thin-film transistor layer. Polarizer layers are located above the color filter layer and below the thin-film transistor layer.

Liquid crystal displays typically include passive display pixels that can alter the amount of light that is transmitted through the display but do not produce light themselves. As a result, it is often desirable to provide backlight for a display with passive pixels such as liquid crystal display pixels.

When it is desired to display images for a user, display driver circuitry applies signals to a grid of data lines and gate lines within the thin-film transistor layer. These signals adjust the electric fields associated with an array of pixels on the thin-film transistor layer. The electric field pattern that is produced controls the liquid crystal material, which in turn controls the transmission of light through the display when displaying images for a user.

It can be difficult to achieve a satisfactory contrast ratio in a liquid crystal display. In edge-lit liquid crystal displays, a light source such as an array of light-emitting diodes emits light into the edge of a light guide plate located behind the display. The light guide plate is used to distribute the backlight uniformly across the display. Thus, in order to display dark colors such as black, the liquid crystal display pixels block light from transmitting through the display to give the appearance of zero luminance. However, the structure of the liquid crystal material is inherently imperfect and some light will always leak through the display. Different regions of a display will also allow different amounts of light to escape in the dark state, resulting in a non-uniform black screen (a phenomenon sometimes referred to as light leakage).

Some displays employ a full array backlight instead of an edge-lit backlight. With this type of configuration, an array of light-emitting diodes is formed directly behind the display. This allows the display to switch off the backlight in the regions where dark colors are being displayed so that the dark colors appear closer to true black. However, full array displays of this type are often thicker than edge-lit displays and typically consume a large amount of power. Moreover, there are a limited number of zones on a full array display that can be locally darkened. This results in a brightened halo around bright objects that are surrounded by darker pixels on the display.

It would therefore be desirable to be able to provide improved displays for electronic devices.

### SUMMARY

An electronic device is provided with a display such as a liquid crystal display mounted in an electronic device housing. The display includes a display module having an array of display pixels. The display module includes a layer of liquid crystal material sandwiched between an upper display layer such as a color filter layer and a lower display layer such as a thin-film transistor layer. An upper polarizer is formed on the upper surface of the color filter layer. A lower polarizer is formed on the lower surface of the thin-film transistor layer.

A backlight unit is used to provide backlight illumination to the display module. The backlight unit may include a light guide plate and a light source that emits light into an edge of the light guide plate. The light guide plate is used to distribute the light uniformly across the display.

The display includes a shutter module having local dimming elements. The local dimming elements are configured to control the amount of light that is transmitted through an overlapping region of the array of display pixels. The local dimming elements may be arranged in a uniform array having rows and columns or the local dimming elements may have different shapes and sizes and may be located in specific regions of the display. For example, the shutter module may include first and second local dimming elements having different sizes. As another example, the shutter module may include one or more elongated local dimming elements that run along one or more edges of the display. Local dimming elements that run along the upper and lower edges of a display can be used to minimize light leakage in these regions (e.g., during a wide-screen movie mode).

The local dimming elements may include liquid crystal display structures, polymer-dispersed liquid crystal display structures, photovoltaic material, electrowetting display structures, and/or other suitable types of light controlling elements.

In one suitable arrangement, the shutter module is located behind the display module (e.g., the shutter module is interposed between the display module and the backlight unit). In another suitable embodiment, the shutter module is arranged in front of the display module (e.g., the display module is interposed between the shutter module and the backlight unit).

Further features, their nature and various advantages will be more apparent from the accompanying drawings and the following detailed description of the preferred embodiments.

### BRIEF DESCRIPTION OF THE DRAWINGS

FIG. 1 is a perspective view of an illustrative electronic device such as a laptop computer with display structures in accordance with an embodiment.

FIG. 2 is a perspective view of an illustrative electronic device such as a handheld electronic device with display structures in accordance with an embodiment.

FIG. 3 is a perspective view of an illustrative electronic device such as a tablet computer with display structures in accordance with an embodiment.

FIG. 4 is a perspective view of an illustrative electronic device such as a computer display with display structures in accordance with an embodiment.

FIG. 5 is a schematic diagram of an illustrative electronic device of the type shown in FIGS. 1, 2, 3, and 4 in accordance with an embodiment.

FIG. 6 a cross-sectional side view of an illustrative display of the type that may be used in devices of the types shown in FIGS. 1, 2, 3, and 4 in accordance with an embodiment.

FIG. 7 is a diagram of an illustrative display in which a display module is interposed between a shutter module and a backlight unit in accordance with an embodiment.

FIG. 8 is a diagram of an illustrative display in which a backlight unit is interposed between a display module and a shutter module in accordance with an embodiment.

FIG. 9 is a cross-sectional side view of an illustrative local dimming element formed from liquid crystal display structures in accordance with an embodiment.

FIG. 10 is a cross-sectional side view of an illustrative local dimming element formed from polymer-dispersed liquid crystal display structures in accordance with an embodiment.

FIG. 11 is a cross-sectional side view of an illustrative local dimming element formed from electrowetting display structures in accordance with an embodiment.

FIG. 12 is a cross-sectional side view of an illustrative local dimming element formed from polymer-dispersed liquid crystal display structures and photovoltaic material in accordance with an embodiment.

FIG. 13 is a top view of an illustrative shutter module having an array of local dimming elements with a resolution that matches that of an array of display pixels in an associated display module in accordance with an embodiment.

FIG. 14 is a top view of an illustrative shutter module having an array of local dimming elements with a resolution that is less than that of an array of display pixels in an associated display module in accordance with an embodiment.

FIG. 15 is a top view of an illustrative shutter module in which the local dimming elements have shapes, sizes, and locations that minimize light leakage in specific regions of the display in accordance with an embodiment.

### DETAILED DESCRIPTION

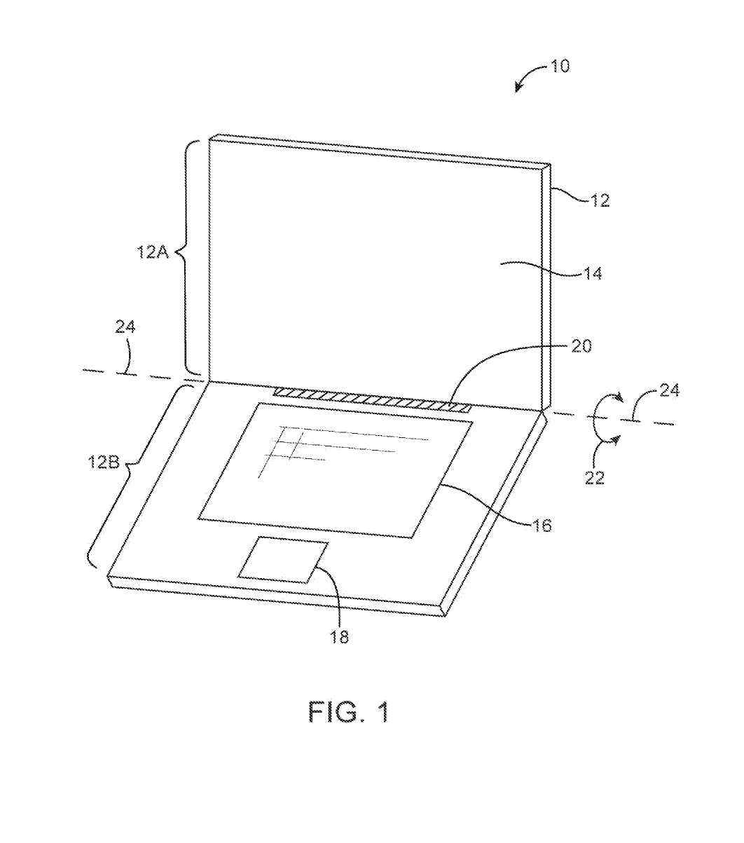

Displays in electronic devices such as liquid crystal displays may be provided with polarizers. Illustrative electronic devices that have displays with polarizers are shown in FIGS. 1, 2, 3, and 4.

Electronic device 10 of FIG. 1 has the shape of a laptop computer and has upper housing 12A and lower housing 12B with components such as keyboard 16 and touchpad 18. Device 10 has hinge structures 20 to allow upper housing 12A to rotate in directions 22 about rotational axis 24 relative to lower housing 12B. Display 14 is mounted in upper housing 12A. Upper housing 12A, which may sometimes referred to as a display housing or lid, is placed in a closed position by rotating upper housing 12A towards lower housing 12B about rotational axis 24.

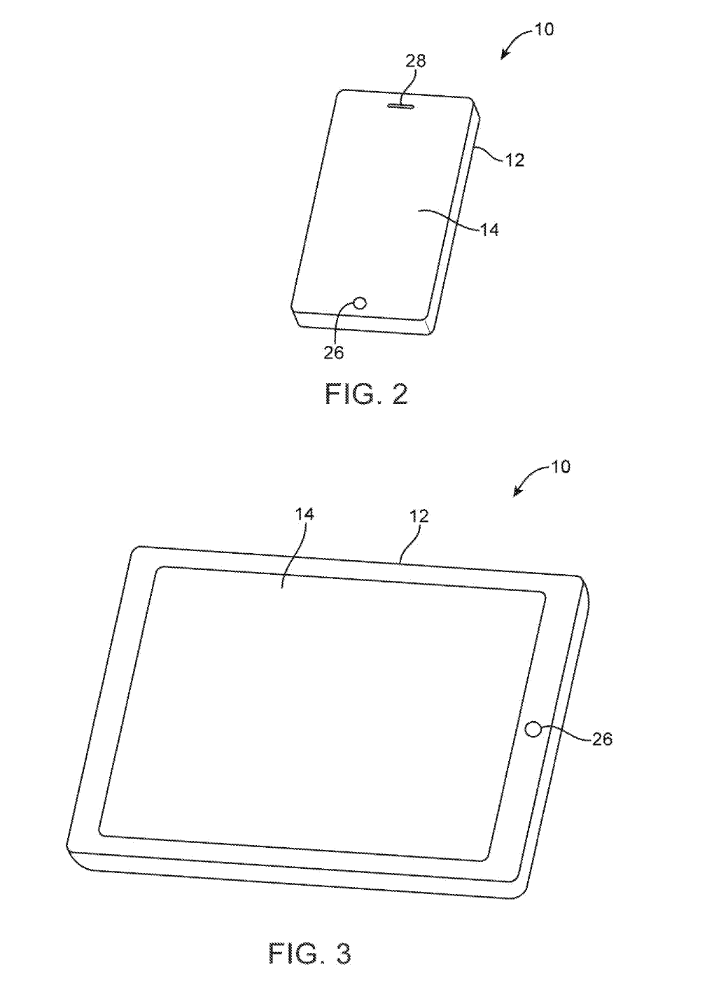

FIG. 2 shows an illustrative configuration for electronic device 10 based on a handheld device such as a cellular telephone, music player, gaming device, navigation unit, or other compact device. In this type of configuration for device 10, housing 12 has opposing front and rear surfaces. Display 14 is mounted on a front face of housing 12. Display 14 may have an exterior layer that includes openings for components such as button 26 and speaker port 28.

In the example of FIG. 3, electronic device 10 is a tablet computer. In electronic device 10 of FIG. 3, housing 12 has opposing planar front and rear surfaces. Display 14 is mounted on the front surface of housing 12. As shown in FIG. 3, display 14 has an external layer with an opening to accommodate button 26.

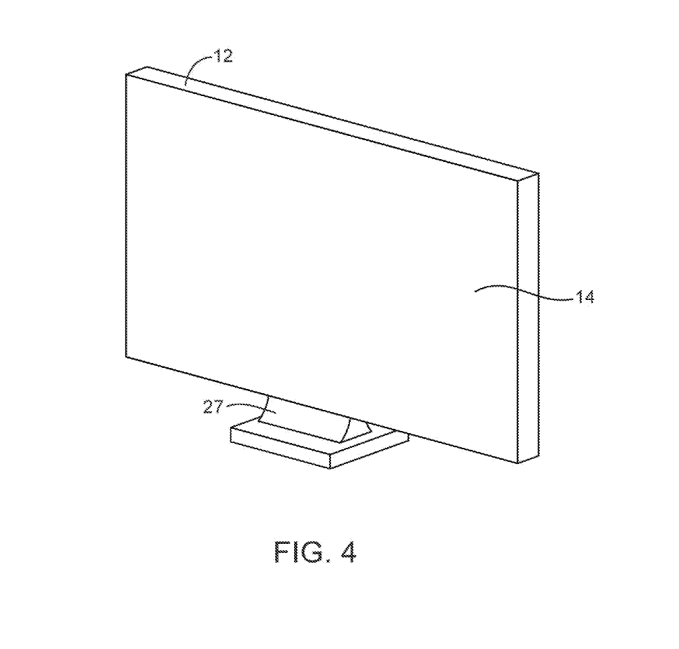

FIG. 4 shows an illustrative configuration for electronic device 10 in which device 10 is a computer display or a computer that has been integrated into a computer display. With this type of arrangement, housing 12 for device 10 is mounted on a support structure such as stand 27. Display 14 is mounted on a front face of housing 12.

The illustrative configurations for device 10 that are shown in FIGS. 1, 2, 3, and 4 are merely illustrative. In general, electronic device 10 may be a laptop computer, a computer monitor containing an embedded computer, a tablet computer, a cellular telephone, a media player, or other handheld or portable electronic device, a smaller device such as a wrist-watch device, a pendant device, a headphone or earpiece device, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, or other electronic equipment.

Housing 12 of device 10, which is sometimes referred to as a case, is formed of materials such as plastic, glass, ceramics, carbon-fiber composites and other fiber-based composites, metal (e.g., machined aluminum, stainless steel, or other metals), other materials, or a combination of these materials. Device 10 may be formed using a unibody construction in which most or all of housing 12 is formed from a single structural element (e.g., a piece of machined metal or a piece of molded plastic) or may be formed from multiple housing structures (e.g., outer housing structures that have been mounted to internal frame elements or other internal housing structures).

Display 14 may be a touch-sensitive display that includes a touch sensor or may be insensitive to touch. Touch sensors for display 14 may be formed from an array of capacitive touch sensor electrodes, a resistive touch array, touch sensor structures based on acoustic touch, optical touch, or force-based touch technologies, or other suitable touch sensor components.

Display 14 for device 10 includes display pixels formed from liquid crystal display (LCD) components or other suitable image pixel structures.

A display cover layer may cover the surface of display 14 or a display layer such as a color filter layer or other portion of a display may be used as the outermost (or nearly outermost) layer in display 14. The outermost display layer may be formed from a transparent glass sheet, a clear plastic layer, or other transparent member.

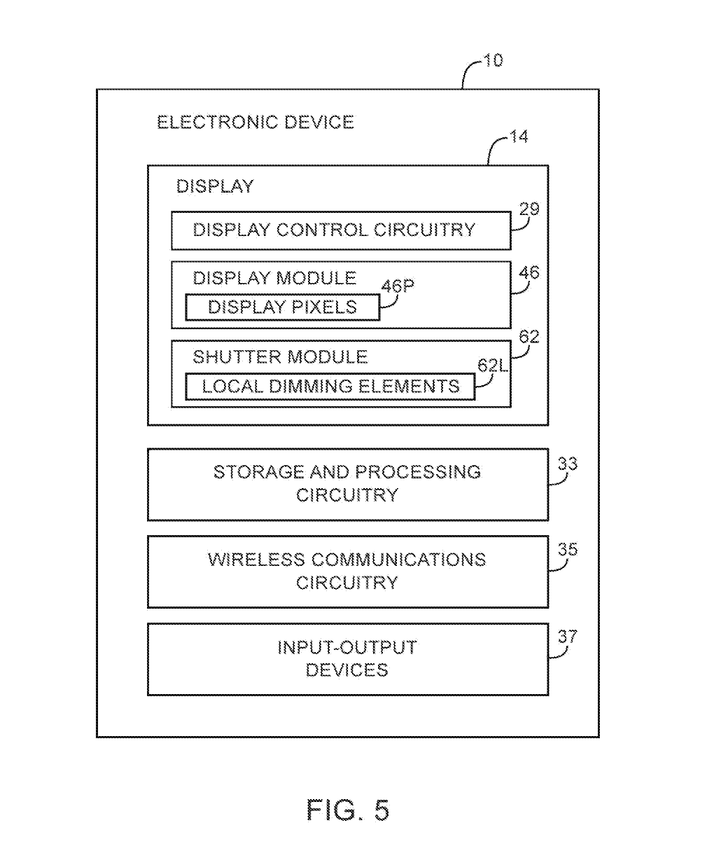

A schematic diagram of electronic device 10 is shown in FIG. 5. As shown in FIG. 5, electronic device 10 includes a display such as display 14. Display 14 includes display module 46 having an array of display pixels 46P, a shutter module such as shutter module 62 having local dimming elements 62L, and display control circuitry 29 for operating display module 46 and shutter module 62.

Display pixels 46P may be formed from reflective components, liquid crystal display (LCD) components, organic light-emitting diode (OLED) components, or other suitable display pixel structures. To provide display 14 with the ability to display color images, display pixels 46P may include color filter elements. Each color filter element may be used to impart color to the light associated with a respective display pixel 46P in pixel array of display 14.

Shutter module 62 is used to help control the amount of light that is emitted by display 14. Shutter module 62 includes local dimming elements 62L, which may be arranged in an array of rows and columns or may have other suitable arrangements. Each local dimming element 62 is used to selectively lighten or darken a localized region of display 14. For example, when it is desired to display black in a selected region of display 14, local dimming elements 62L in a corresponding region of shutter module 62 are manipulated to block light from transmitting through display 14 in the selected region. Local dimming elements 62L may be formed from liquid crystal display structures, polymer-dispersed liquid crystal display structures, reflective display structures, electrowetting display structures, electrophoretic display structures, microelectromechanical systems-based shutter elements, photovoltaic materials, and/or other suitable light-controlling structures.

Display control circuitry 29 may include a graphics controller (sometimes referred to as a video card or video adapter) that may be used to provide video data and control signals to display 14. Video data may include text, graphics, images, moving video content, or other content to be presented on display 14.

Display control circuitry 29 may also include display driver circuitry. Display driver circuitry in circuitry 29 may be implemented using one or more integrated circuits (ICs) and is sometimes be referred to as a driver IC, display driver integrated circuit, or display driver. If desired, the display driver integrated circuit may be mounted on an edge of a thin-film-transistor substrate layer in display 14 (as an example). Display control circuitry 29 may include timing controller (TCON) circuitry such as a TCON integrated circuit. The timing controller may be used to supply pixel signals to display pixels 46P and local dimming signals to local dimming elements 62L.

the timing controller supplies data line and gate line signals to both display module 46 and shutter structures 62.

Display control circuitry 29 may be coupled to additional circuitry in device 10 such as storage and processing circuitry 33. Storage and processing circuitry 33 in device 10 may include microprocessors, microcontrollers, digital signal processor integrated circuits, application-specific integrated circuits, and other processing circuitry. Volatile and non-volatile memory circuits such as random-access memory, read-only memory, hard disk drive storage, solid state drives, and other storage circuitry may also be included in circuitry 33. Display calibration information may be stored using circuitry 33 or may be stored using display control circuitry 29 or other circuitry associated with display 14.

Circuitry 33 may use wireless communications circuitry 35 and/or input-output devices 37 to obtain user input and to provide output to a user. Input-output devices 37 may include speakers, microphones, sensors, buttons, keyboards, displays, touch sensors, and other components for receiving input and supplying output. Wireless communications circuitry 35 may include wireless local area network transceiver circuitry, cellular telephone network transceiver circuitry, and other components for wireless communication.

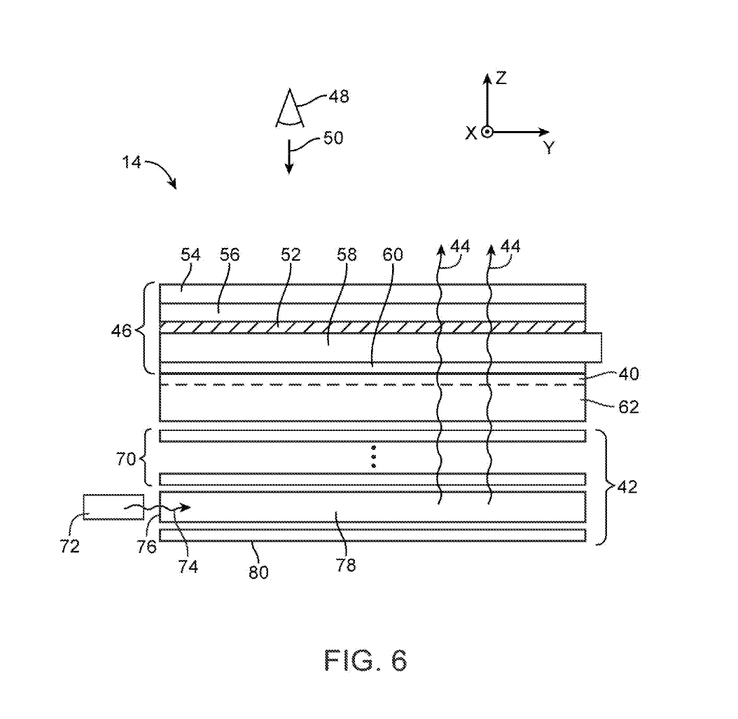

A cross-sectional side view of an illustrative configuration for display 14 of device 10 (e.g., for display 14 of the devices of FIG. 1, FIG. 2, FIG. 3, FIG. 4 or other suitable electronic devices) is shown in FIG. 6. As shown in FIG. 6, display 14 includes backlight structures such as backlight unit 42 for producing backlight 44. During operation, backlight 44 travels outwards (vertically upwards in dimension Z in the orientation of FIG. 6) and passes through display pixel structures in display layers 46. This illuminates any images that are being produced by the display pixels for viewing by a user. For example, backlight 44 illuminates images on display layers 46 that are being viewed by viewer 48 in direction 50.

Display layers 46 may be mounted in chassis structures such as a plastic chassis structure and/or a metal chassis structure to form a display module for mounting in housing 12 or display layers 46 may be mounted directly in housing 12 (e.g., by stacking display layers 46 into a recessed portion in housing 12). Display layers 46 form a liquid crystal display or may be used in forming displays of other types.

In a configuration in which display layers 46 are used in forming a liquid crystal display, display layers 46 include a liquid crystal layer such as liquid crystal layer 52. Liquid crystal layer 52 is sandwiched between display layers such as display layers 58 and 56. Layers 56 and 58 are interposed between lower polarizer layer 60 and upper polarizer layer 54. Display layers 46 are sometimes referred to herein collectively as “display module.”

Layers 58 and 56 are formed from transparent substrate layers such as clear layers of glass or plastic. Layers 56 and 58 are layers such as a thin-film transistor layer (e.g., a thin-film transistor substrate such as a glass layer coated with a layer of thin-film transistor circuitry) and/or a color filter layer (e.g., a color filter layer substrate such as a layer of glass having a layer of color filter elements such as red, blue, and green color filter elements arranged in an array). Conductive traces, color filter elements, transistors, and other circuits and structures are formed on the substrates of layers 58 and 56 (e.g., to form a thin-film transistor layer and/or a color filter layer). Touch sensor electrodes may also be incorporated into layers such as layers 58 and 56 and/or touch sensor electrodes may be formed on other substrates.

With one illustrative configuration, layer 58 is a thin-film transistor layer that includes an array of thin-film transistors and associated electrodes (display pixel electrodes) for applying electric fields to liquid crystal layer 52 and thereby displaying images on display 14. Layer 56 is a color filter layer that includes an array of color filter elements for providing display 14 with the ability to display color images. If desired, layer 58 may be a color filter layer and layer 56 may be a thin-film transistor layer.

Display module 46 is illuminated with backlight 44 provided by backlight structures 42. In the example of FIG. 6, backlight structures 42 include a light guide plate such as light guide plate 78. Light guide plate 78 is formed from a transparent material such as clear glass or plastic. During operation of backlight structures 42, a light source such as light source 72 generates light 74. Light source 72 may be, for example, an array of light-emitting diodes.

Light 74 from one or more light sources such as light source 72 is coupled into one or more corresponding edge surfaces such as edge surface 76 of light guide plate 78 and is distributed in dimensions X and Y throughout light guide plate 78 due to the principal of total internal reflection. Light guide plate 78 includes light-scattering features such as pits or bumps. The light-scattering features are located on an upper surface and/or on an opposing lower surface of light guide plate 78.

Light 74 that scatters upwards in direction Z from light guide plate 78 serves as backlight 44 for display 14. Light 74 that scatters downwards is reflected back in the upwards direction by reflector 80. Reflector 80 is formed from a reflective material such as a layer of white plastic or other shiny materials. The use of a reflector in backlight 42 is, however, merely illustrative and may not be needed in some configurations.

The configuration of FIG. 6 in which backlight structures 42 form part of an edge-lit display is merely illustrative. If desired, other suitable types of backlights may be used in display 14. For example, backlight structures 42 may include an array of light-emitting diodes or an array of organic light-emitting diodes formed behind display module 46 or may include other light sources such as a cold-cathode florescent lamp.

To enhance backlight performance for backlight structures 42, backlight structures 42 optionally include optical films 70. Optical films 70 include diffuser layers for helping to homogenize backlight 44 and thereby reduce hotspots, compensation films for enhancing off-axis viewing, and brightness enhancement films (also sometimes referred to as turning films) for collimating backlight 44. Optical films 70 overlap the other structures in backlight unit 42 such as light guide plate 78 and reflector 80. For example, if light guide plate 78 has a rectangular footprint in the X-Y plane of FIG. 6, optical films 70 and reflector 80 preferably have a matching rectangular footprint. The configuration of FIG. 6 in which optical films 70 are located directly above light guide plate 78 is merely illustrative. If desired, optical films 70 may be located elsewhere in display 14.

Display 14 includes a shutter module such as shutter module 62. Shutter module 62 is used to help control the amount of backlight 44 that is transmitted through display 14 (upwards in dimension Z in the configuration of FIG. 6). When it is desired to display dark colors on display 14 such as black and dark grays, shutter module 62 is used to block light from transmitting through display 14. Dark colors such as black and dark grays will therefore appear closer to true black and true dark grays, respectively. When it is desired to display lighter colors on display 14, shutter module 62 allows some or all of backlight 44 to pass through display 14.

Shutter module 62 includes local dimming elements 62L (FIG. 5). Each local dimming element is configured to control the amount of light that is transmitted through a given region of display 14. Local dimming elements 62L in shutter module 62 can have different shapes and sizes or local dimming elements 62L can all have the same shape and size. In one suitable embodiment, local dimming elements 62L are arranged in an array of rows and columns. Local dimming elements 62L can have the same resolution as display pixels 46P (FIG. 5) in display module 46 or local dimming elements 62L can have a resolution that is greater or less than the resolution of display pixels 46P in display module 46.

Each local dimming element 62L is configured to control light transmission independently of the other local dimming elements in shutter module 62. Local dimming elements 62L can be controlled using data line signals on data lines and gate line signals on gate lines. Because shutter module 62 is used to control the transmission of light from display 14, shutter module 62 need not include color filter elements (e.g., shutter module 62 may include monochromatic display structures). However, if desired, shutter module 62 can include color filter elements.

Shutter module 62 may be assembled with other display structures in display 14 in any suitable fashion. In one suitable embodiment, shutter module 62 is laminated to display module 46 using an adhesive such as optically clear adhesive 84. In another suitable embodiment, layer 84 is an air gap that separates display module 46 from shutter module 62. If desired, display module 46 and shutter module 62 may be manufactured as a single panel and layer 84 may be omitted.

During operation of display 14, control circuitry in device 10 (e.g., circuitry 33 of FIG. 5) is used to generate information to be displayed on display 14 (e.g., display data). The information to be displayed is conveyed from the control circuitry to display control circuitry 29 (e.g., a display driver integrated circuit that is mounted on a ledge of thin-film transistor layer 58 or elsewhere in device 10). If desired, a flexible printed circuit cable can be used in routing signals between the control circuitry and thin-film-transistor layer 58.

If desired, a single display control circuit (e.g., a timing controller (TCON) integrated circuit in circuitry 29 of FIG. 5) may be used to control both display module 46 and shutter module 62. With this type of configuration, the timing controller supplies data line and gate line signals to both display module 46 and shutter structures 62. If desired, the timing of signals provided to display pixels 46P of display module 46 and of signals provided to local dimming elements 62L of shutter module 62 can be synchronized. For example, when a selected display pixel 46P in display module 46 displays black, a corresponding local dimming element 62L in shutter module 62 (e.g., a local dimming element overlapping the selected display pixel) is manipulated to block light from transmitting through display 14.

The use of a single timing controller integrated circuit to control both display module 46 and shutter module 62 is merely illustrative. If desired, a first timing controller integrated circuit can be used to control display module 46 and a second timing controller integrated circuit can be used to control shutter module 62.

In the example of FIG. 6, shutter module 62 is interposed between display module 46 and backlight 42. With this type of configuration, light 44 generated by backlight structures 42 has to pass through shutter module 62 before passing through display module 46. When it is desired to display dark colors in a given region of display 14, local dimming elements 62L in a corresponding region of shutter module 62 (e.g., a region overlapping the region where dark colors are to be displayed) are manipulated so that light is prevented from transmitting through shutter module 62 in that region. When it is desired to display lighter colors in a given region of display 14, local dimming elements 62L in a corresponding region of shutter module 62 are manipulated so that light is allowed to pass through shutter module 62 in that region.

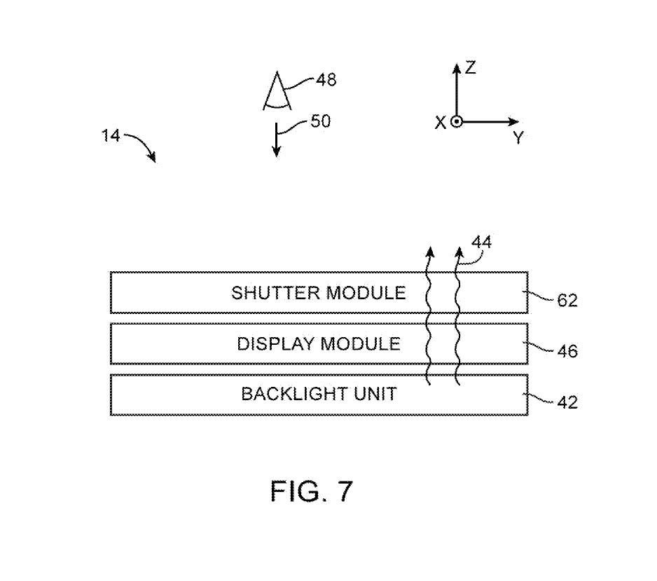

This is however, merely illustrative. If desired, shutter module 62 may be located in front of display module 46. This type of configuration is shown in FIG. 7. As shown in FIG. 7, display module 46 is interposed between shutter module 62 and backlight structures 42. Images that are being viewed by viewer 48 in direction 50 are illuminated by backlight 44 from backlight structures 42. When it is desired to display dark colors such as black, local dimming elements in shutter module 62 are manipulated to block backlight 44 transmitted from display module 46 from passing through shutter module 62 in direction Z. When it is desired to display lighter colors, local dimming elements in shutter module 62 are manipulated such that light transmitted from display module 46 is allowed to pass through shutter module 62.

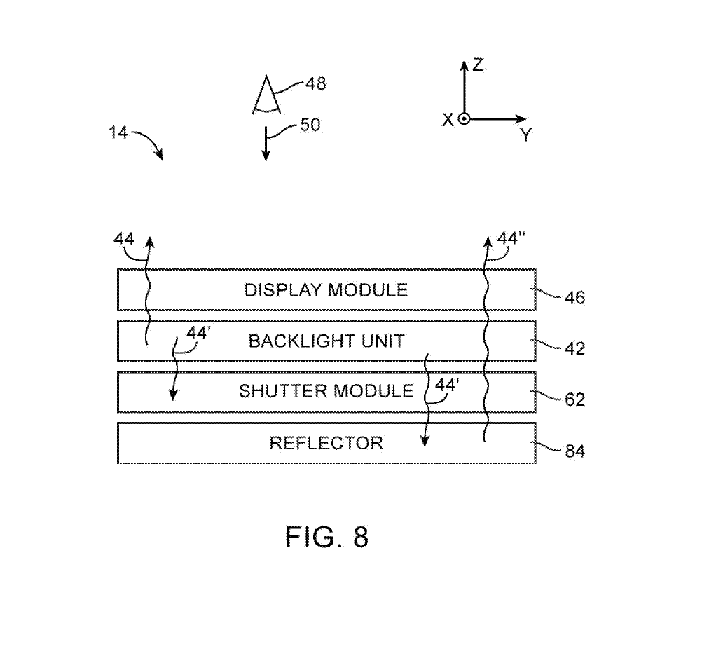

In another suitable embodiment, shutter module 62 is located behind backlight structures 42. This type of configuration is shown in FIG. 8. As shown in FIG. 8, backlight structures 42 may be interposed between display module 46 and shutter module 62. When it is desired to display lighter colors in a selected region of display module 46, local dimming elements in a corresponding region of shutter module 62 are transmissive. This in turn allows light 44′ that scatters downward from backlight 42 to pass through module 62 towards reflector 84. Light 44″ that is reflected by reflector 84 will travel upwards in direction Z and will illuminate display module 46. When it is desired to display dark colors such as black in a given region of display module 46, local dimming elements in a corresponding region of shutter module 62 will block light 44′ that scatters downward from backlight structures 42. This prevents light 44′ from being reflected in direction Z towards viewer 48.

If desired, backlight structures 42 may be omitted. With this type of configuration, shutter module 62 operates in the same manner described above. However, rather than blocking or transmitting light from a backlight, shutter module 62 is used to control the transmission of ambient light. When a region of shutter module 62 is transmissive, ambient light will pass through that region of shutter module 62 and will be reflected by reflector 84. The reflected light will illuminate a corresponding region of display module 46. When a region of shutter module 62 is not transmissive, the corresponding region of display module 46 will be dark (e.g., black) because ambient light will be unable to reach reflector 84 behind shutter module 62.

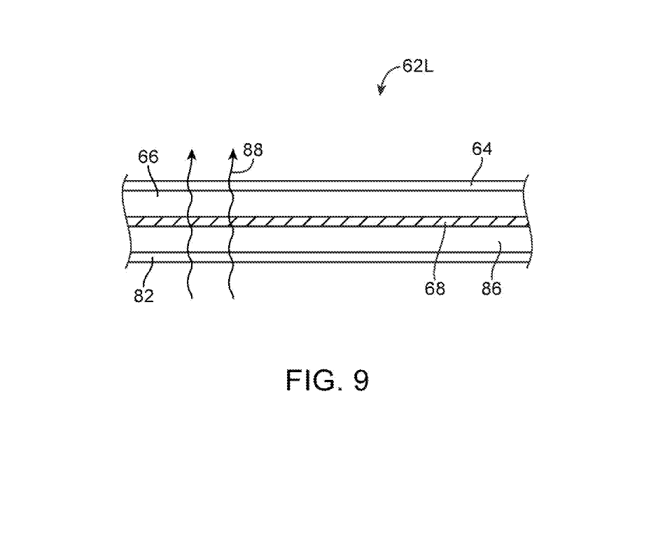

In one suitable embodiment, local dimming elements 62L in shutter module 62 are formed from liquid crystal display structures. This type of configuration is shown in FIG. 9. As shown in FIG. 9, local dimming element 62L includes a liquid crystal layer such as liquid crystal layer 68. Liquid crystal layer 68 is sandwiched between upper and lower substrate layers such as substrate layers 66 and 86. Layers 66 and 86 are interposed between lower polarizer layer 82 and upper polarizer layer 64.

Layers 66 and 86 are formed from transparent substrate layers such as clear layers of glass or plastic. Layers 86 may, for example, be a thin-film transistor layer (e.g., a thin-film transistor substrate such as a glass layer coated with a layer of thin-film transistor circuitry). Conductive traces, transistors, and other circuits and structures are formed on substrate layer 86 (e.g., to form a thin-film transistor layer). If desired, layer 66 may be a thin-film transistor layer. The configuration of FIG. 9 is merely illustrative.

Because shutter module 62 is used for controlling light transmission rather than displaying images, local dimming element 62L need not include color filter elements. However, if it is desired to provide shutter module 62 with the ability to filter light of different wavelengths, layer 66 may be a color filter layer (e.g., a color filter layer substrate such as a layer of glass having a layer of color filter elements such as red, blue, and green color filter elements arranged in an array).

Layer 86 can include one or more thin-film transistors and associated electrodes (local dimming electrodes) for applying electric fields to liquid crystal layer 68 and thereby controlling the amount of light transmitted through local dimming element 62L.

As light 88 passes through lower polarizer 82, lower polarizer 82 polarizes light 88. As polarized light 88 passes through liquid crystal material 68, liquid crystal material 68 rotates the polarization of light 88 by an amount that is proportional to the electric field through liquid crystal material 68. If the polarization of light 88 is aligned in parallel with the polarization of upper polarizer 64, the transmission of light 88 through layer 64 will be maximized. If the polarization of light 88 is aligned so as to run perpendicular to the polarization of polarizer 64, the transmission of light 88 through layer 64 will be minimized (i.e., light 88 will be blocked). Display control circuitry 29 (e.g., a timing controller) that controls display module 46 can also be used in adjusting the voltages across the local dimming electrodes in local dimming element 62L, thereby selectively lightening and darkening localized regions of display 14.

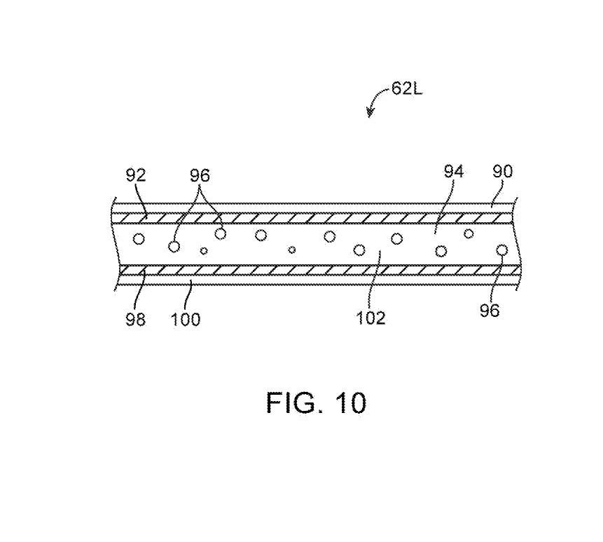

In another suitable embodiment, local dimming elements 62L in shutter module 62 are formed from polymer-dispersed liquid crystal display structures. This type of configuration is shown in FIG. 10. As shown in FIG. 10, local dimming element 62L includes a polymer-dispersed liquid crystal layer such as polymer-dispersed liquid crystal layer 94. Shutter modules having local dimming elements 62L formed from polymer-dispersed liquid crystal structures are sometimes referred to as polymer-dispersed liquid crystal modules or polymer-dispersed liquid crystal display modules.

Polymer-dispersed liquid crystal layer 94 includes liquid crystal droplets 96 dispersed in solid polymer matrix 102. Layer 94 is interposed between upper substrate 90 and lower substrate 100. Upper and lower substrate layers 90 and 100 are formed from transparent substrate layers such as clear layers of plastic or glass. Upper substrate layer 90 is coated with a conductive material such as transparent conductive material 92 (e.g., a thin coating of indium tin oxide or other transparent conductive material). Lower substrate layer 100 is also coated with a conductive material such as transparent conductive material 98 (e.g., a thin coating of indium tin oxide or other transparent conductive material). Polymer-dispersed liquid crystal layer 94 is sandwiched between conductive coatings 92 and 98 (sometimes referred to herein as upper and lower ITO coatings).

Upper and lower ITO coatings are used for applying electric fields to polymer-dispersed liquid crystal layer 94 and thereby controlling the amount of light transmitted through local dimming element 62L. The transmission of light through layer 94 of local dimming element 62L depends on the amount of scattering that occurs as light strikes layer 94. The amount of light scattering in turn depends on the orientation of liquid crystal droplets 96. In the absence of an applied voltage, liquid crystal droplets 96 are dispersed in polymer 102 in a random array. This maximizes the amount of scattering that occurs as light is incident on layer 94 and therefore minimizes the transmission of light through local dimming element 62L. When a voltage is applied across layer 94, the electric field that is produced across layer 94 causes liquid crystal droplets 96 to align with the electric field. This minimizes the amount of scattering that occurs as light is incident on layer 94 and therefore maximizes the transmission of light through local dimming element 62L.

Display control circuitry 29 (e.g., a timing controller) that controls display module 46 can also be used in adjusting the electric field across layer 94 in local dimming element 62L, thereby selectively lightening and darkening localized regions of display 14.

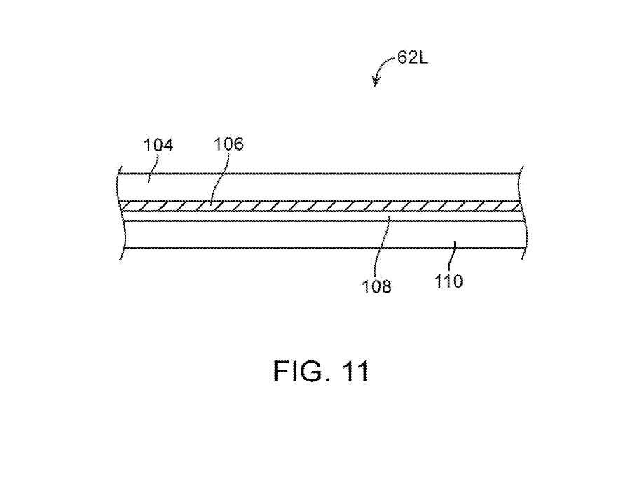

In another suitable embodiment, local dimming elements 62L in shutter module 62 are formed from electrowetting display structures. This type of configuration is shown in FIG. 11. As shown in FIG. 11, local dimming element 62L includes an insulator layer such as hydrophobic insulator layer 108 formed on an upper surface of an electrode layer such as electrode layer 110. A layer of colored oil such as colored oil 106 is interposed between hydrophobic insulator 108 and an electrolyte layer such as electrolyte layer 104 (e.g., a layer of water).

In an equilibrium state (i.e., in the absence of an applied voltage), colored oil 106 forms a flat film on the surface of insulator 108. When a voltage is applied across insulator 108, the equilibrium state changes and it requires less energy for water 104 to rest on the surface of insulator 108. Thus, colored oil 106 is pushed to the side when a voltage is applied across hydrophobic insulator 108.

If desired, colored oil 106 may be opaque such as black and electrode 110 may be a transparent electrode. With this type of configuration, light transmission through local dimming element 62L is minimized when no voltage is applied across insulator 108 so that opaque oil 106 forms a flat film on the surface of insulator 108. Light transmission through shutter module 62 is maximized when a voltage is applied across insulator 108 so that opaque oil 106 moves to the side and light is allowed to pass through local dimming element 62L.

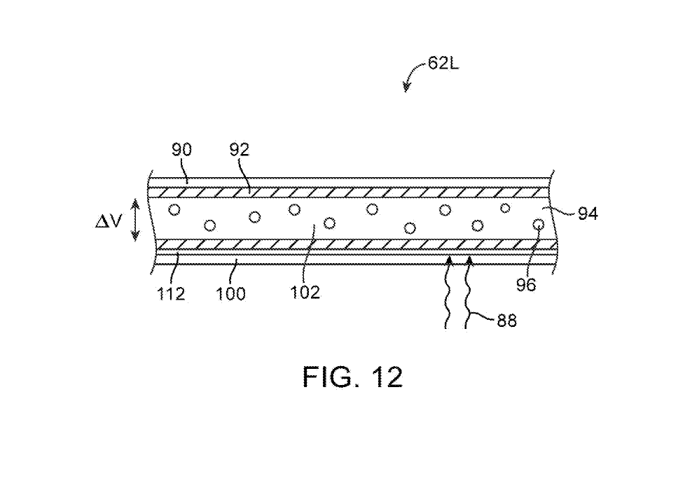

In another suitable embodiment, local dimming elements 62L in shutter module 62 are formed from polymer-dispersed liquid crystal structures and photovoltaic material. This type of configuration is shown in FIG. 12. As shown in FIG. 12, local dimming element 62L includes a polymer-dispersed liquid crystal layer such as polymer-dispersed liquid crystal layer 94. Polymer-dispersed liquid crystal layer 94 includes liquid crystal droplets 96 dispersed in solid polymer matrix 102. Layer 94 is interposed between upper substrate 90 and lower substrate 100. Upper and lower substrate layers 90 and 100 are formed from transparent substrate layers such as clear layers of plastic or glass. Upper substrate layer 90 is coated with a conductive material such as transparent conductive material 92 (e.g., a thin coating of indium tin oxide or other transparent conductive material). Lower substrate layer 100 is coated with photovoltaic material such as photovoltaic material 112. Polymer-dispersed liquid crystal layer 94 is sandwiched between conductive structure 92 and photovoltaic material 112.

Conductive structure 92 and photovoltaic material 112 are used for applying electric fields to polymer-dispersed liquid crystal layer 94 and thereby controlling the amount of light transmitted through local dimming element 62L. The transmission of light through layer 94 of local dimming element 62L depends on the amount of scattering that occurs as light strikes layer 94. The amount of light scattering in turn depends on the orientation of liquid crystal droplets 96. In the absence of an applied voltage, liquid crystal droplets 96 are dispersed in polymer 102 in a random array. This maximizes the amount of scattering that occurs as light is incident on layer 94 and therefore minimizes the transmission of light through local dimming element 62L. When a voltage is applied across layer 94, the electric field that is produced across layer 94 causes liquid crystal droplets 96 to align with the electric field. This minimizes the amount of scattering that occurs as light is incident on layer 94 and therefore maximizes the transmission of light through local dimming element 62L.

The voltage across layer 94 is proportional to the intensity of backlight 88 as it strikes photovoltaic material 112. Upper conductive coating 92 is electrically grounded such that, when backlight 88 strikes photovoltaic material 112, a voltage difference ΔV is produced across layer 94. The corresponding electric field produced across layer 94 in turn controls liquid crystal droplets 96 in layer 94. When it is desired to display darker colors such as black, the intensity of backlight 88 (e.g., backlight 88 that is transmitted through display module 46) is minimized, which in turn minimizes the voltage difference ΔV that is produced across layer 94. Liquid crystal droplets 96 will therefore be arranged in a random array, thereby preventing backlight 88 from passing through shutter module 62.

With this type of configuration, it may not be required to supply control signals (e.g., control signals that are synchronized with the display control signals provided to display pixels 46P in display module 46) to local dimming elements 62L of shutter module 62. Transmission of light through local dimming elements 62L of shutter module 62 is controlled by the voltage difference ΔV across layer 94, which in turn is controlled by the intensity of backlight 88 as it strikes photovoltaic material 112. This type of configuration is sometimes referred to as “passive timing” because local dimming elements 62L in shutter module 62 are operated automatically by backlight 88 from backlight structures 42.

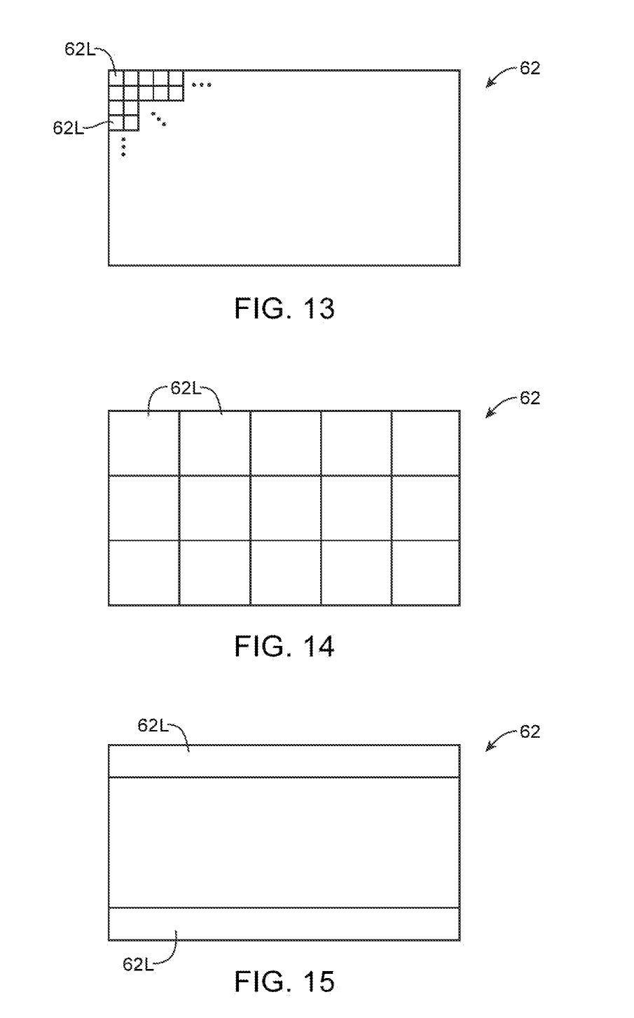

Local dimming elements 62L of shutter module 62 can be arranged in any suitable pattern and can have any suitable resolution. As shown in FIG. 13, for example, local dimming elements 62L may be arranged in an array of rows and columns. The array of local dimming elements 62L may have the same resolution as the array of display pixels 46P in display module 46 or the array of local dimming elements 62L may have a greater resolution than that of the array of display pixels 46P in display module 46. If desired, each local dimming element 62L may be aligned and overlapping with an associated display pixel 46P in display module 46.

In the example of FIG. 14, local dimming elements 62L of shutter module 62 are arranged in an array of rows and columns having a smaller resolution than that of the array of display pixels 46P in display module 46. As examples, the ratio of display pixels 46P to local dimming elements 62L may be 2:1, 4:1, 16:1, 32:1, 64:1, or may be any other suitable ratio for providing localized light control in display 14.

If desired, the shape, size, number, and location of local dimming elements 62L in shutter module 62 can be customized for display 14. For example, local dimming elements 62L can be located in regions that tend to be more susceptible to light leakage. For example, display 14 may sometimes be used to display movies in a wide-screen viewing mode. In this type of viewing mode, the upper and lower borders of the display may remain black while the movie is displayed in a central region of the display. If desired, shutter module 62 can be customized based on specific display usage modes such as the wide-screen movie display mode. For example, as shown in FIG. 15, shutter module 62 has a first local dimming element 62L that forms an elongated strip along the upper border of display 14 and a second local dimming element 62L that forms an elongated strip along the lower border of display 14. Upper and lower local dimming elements 62L control the amount of light that is transmitted from the upper and lower regions of display 14, respectively. When displaying a wide-screen movie on display 14, local dimming elements 62L are used to block light in the upper and lower borders of display 14 such that these regions appear dark and light leakage is minimized.

The example of FIG. 15 is merely illustrative. In general, local dimming elements 62L can have any suitable shape, size, number, and location in shutter module 62. For example, there may be one or more local dimming elements running along each of the four sides of display 14 or there may be one contiguous local dimming element that runs along the entire periphery of display 14. If desired, there may be display pixels 46P or regions of display pixels 46P that do not overlap local dimming elements 62L.

The arrangement of local dimming elements 62L may be customized based on display performance information that is gathered from display 14 during manufacturing. For example, a camera may be used to capture one or more images of display 14 in a given mode of operation (e.g., while display 14 is completely black). The captured images may in turn be used to determine which regions of display 14 exhibit light leakage. Local dimming elements 62L of shutter module 62 can be arranged based on the display performance information such that light leakage in display 14 is minimized.

The foregoing is merely illustrative and various modifications can be made by those skilled in the art without departing from the scope and spirit of the described embodiments. The foregoing embodiments may be implemented individually or in any combination.

What is claimed is:

1. A display, comprising:
a display module having an array of display pixels; and
a shutter module having a plurality of local dimming elements, wherein each of the local dimming elements comprises a polymer-dispersed liquid crystal layer and is configured to control the amount of light that is transmitted through at least one of the display pixels.

2. The display defined in claim 1 further comprising backlight structures configured to provide backlight illumination to the display module, wherein the shutter module is interposed between the display module and the backlight structures.

3. The display defined in claim 1 further comprising backlight structures configured to provide backlight illumination to the display module, wherein the display module is interposed between the shutter module and the backlight structures.

4. The display defined in claim 3 wherein each local dimming element comprises photovoltaic material interposed between the polymer-dispersed liquid crystal layer and the display module.

5. The display defined in claim 1 wherein the local dimming elements are arranged in an array having rows and columns, wherein the array of local dimming elements has a first resolution and the array of display pixels has a second resolution, and wherein the first resolution is less than the second resolution.

6. The display defined in claim 1 wherein the display module comprises a thin-film transistor layer, a color filter layer, and liquid crystal material interposed between the thin-film transistor layer and the color filter layer.

7. The display defined in claim 1 further comprising backlight structures configured to provide backlight illumination to the display module, wherein the backlight structures comprise a light guide plate and a light source configured to emit light into an edge of the light guide plate.

8. The display defined in claim 1 wherein the local dimming elements comprise a first elongated local dimming element that runs along a first edge of the display and a second elongated local dimming element that runs along a second edge of the display.

9. The display defined in claim 1 further comprising a timing controller integrated circuit configured to provide display signals to the display pixels and local dimming signals to the local dimming elements.

10. The display defined in claim 9 wherein the display signals and the local dimming signals are synchronized.

11. The display defined in claim 1 wherein the display module and the shutter module are laminated together.

12. A display, comprising:
at least one display layer having an array of display pixels;
a first local dimming element overlapping a first region of the array of display pixels and configured to control the amount of light transmitted through the first region of the array of display pixels; and
a second local dimming element overlapping a second region of the array of display pixels and configured to control the amount of light transmitted through the second region of the array of display pixels, wherein the first local dimming element and the second local dimming element have different sizes.

13. The display defined in claim 12 wherein the first and second local dimming elements each comprise liquid crystal material.

14. The display defined in claim 12 wherein the first and second local dimming elements each comprise liquid crystal droplets dispersed in a polymer matrix.

15. The display defined in claim 12 wherein the first and second local dimming elements each comprise electrowetting display structures.

16. The display defined in claim 12 further comprising a backlight unit configured to provide backlight to the at least one display layer, wherein the first and second local dimming elements are configured to control the amount of backlight that is respectively transmitted through the first and second regions of the array of display pixels.

17. A display, comprising:
a liquid crystal display module having an array of display pixels;
a polymer-dispersed liquid crystal display module; and
a backlight unit configured to provide backlight to the array of display pixels.

18. The display defined in claim 17 wherein the polymer-dispersed liquid crystal display module comprises an array of local dimming elements, wherein each local dimming element comprises polymer-dispersed liquid crystal material, and wherein each local dimming element is configured to control the amount of light that is transmitted through the polymer-dispersed liquid crystal material associated with that local dimming element.

19. The display defined in claim 17 wherein the liquid crystal display module is interposed between the polymer-dispersed liquid crystal display module and the backlight unit.

20. The display defined in claim 17 wherein the polymer-dispersed liquid crystal display module is interposed between the liquid crystal display module and the backlight unit.
